(19) United States
(12) Patent Application Publication
(10) Pub. No.: US 2018/0227589 A1
(43) Pub. Date: Aug. 9, 2018

(54) INFORMATION PROCESSING METHOD, MOBILE TERMINAL, AND COMPUTER STORAGE MEDIUM

(71) Applicant: NUBIA TECHNOLOGY CO., LTD, Shenzhen (CN)

(72) Inventor: Linwen LIU, Shenzhen (CN)

(21) Appl. No.: 15/769,902

(22) PCT Filed: Oct. 9, 2016
(86) PCT No.: PCT/CN2016/101590

§ 371 Date: Apr. 20, 2018

(30) Foreign Application Priority Data
Oct. 21, 2015 (CN) 201510695985.9

(51) Int. Cl. H04N 19/44; H04N 19/172; G06T 9/00

(52) U.S. Cl. CPC H04N 19/44; H04M 1/72522; G06T 9/004; H04N 19/172

(57) ABSTRACT

Embodiments of the present disclosure provide an information processing method, a mobile terminal, and a computer storage medium. The mobile terminal includes a decoding unit configured to obtain a first multimedia file, decode the first multimedia file, and obtain multiple frames of decoded first pictures and a time parameter of the first multimedia file; a first processing unit configured to obtain a first input operation for any selected frame of the first pictures obtained by the decoding unit; a second processing unit configured to identify an area in each of the other frames of the first pictures except the selected frame of the first pictures corresponding to the first area of the selected frame as a first area of each of the other frames, and perform predetermined processing on areas except the first areas of the multiple frames of first pictures to generate multiple frames of second pictures; and an encoding unit configured to encode the multiple frames of second pictures according to the time parameter to generate a second multimedia file.

### FIELD OF THE DISCLOSURE

The present disclosure relates to information processing technologies and, in particular, relates to an information processing method, a mobile terminal, and a computer storage medium.

### BACKGROUND

Current technology allows a mobile terminal generally display a dynamic image of a specific format. For example, the dynamic image can be a GIF (Graphics Interchange Format) picture, or can be generated by using an application. However, at present, the mobile terminal cannot locally process the dynamic image, that is, the dynamic effect of the local area in the dynamic image is preserved, and the other areas are treated as the static-effect display.

### BRIEF SUMMARY OF THE DISCLOSURE

To solve the existing technical problems, embodiments of the present disclosure provide an information processing method, a mobile terminal, and a computer storage medium to perform local processing on a dynamic picture and preserve dynamic effect of a local area in the dynamic picture.

To achieve the above objective, the technical solution of the embodiments of the present disclosure is implemented as follows:

Embodiments of the present disclosure provide a mobile terminal, and the mobile terminal includes a decoding unit, a first processing unit, a second processing unit and an encoding unit.

The decoding unit is configured to obtain a first multimedia file, decode the first multimedia file, and obtain multiple frames of decoded first pictures and a time parameter of the first multimedia file.

The first processing unit is configured to obtain a first input operation for any selected frame of the first pictures obtained by the decoding unit.

The second processing unit is configured to identify an area in each of the other frames of the first pictures except the selected frame of the first pictures corresponding to the first area of the selected frame as a first area of each of the other frames, and perform predetermined processing on areas except the first areas of the multiple frames of first pictures to generate multiple frames of second pictures.

The encoding unit is configured to encode the multiple frames of second pictures according to the time parameter to generate a second multimedia file.

In one embodiment, the second processing unit is configured to identify a relative positional relationship of the first area in the any frame of the picture; according to the relative positional relationship, determining the first area in the other frame pictures except the any frame of the first picture; the first area of the other frame pictures satisfy the relative location relationship.

In one embodiment, the first processing unit is further configured to obtain a second input operation, before obtaining the first input operation for any frame of the first picture obtained by the decoding unit, determining a processing mode according to the second input operation; the processing mode comprises an incrementing mode and a deleting mode.

In one embodiment, the second processing unit is configured to obtain at least two first input operations for any frame of the first picture under the condition that the processing mode is the deleting mode, determining a local area according to the previous first input operation, and determining a temporary area according to a subsequent first input operation; determining the first area after deleting the temporary area from the local area.

In one embodiment, the second processing unit is configured to obtain at least two first input operations for any frame of the first picture under the condition that the processing mode is the incrementing mode, determining a local area according to the previous first input operation, and determining a temporary area according to a subsequent first input operation; determining the combination of the local area and the temporary area as the first area.

In one embodiment, the mobile terminal further comprising a display unit, configured to arrange the multiple frames of pictures in the order of the multiple frames of pictures, output and display the arranged multiple frames of pictures, before the first processing unit obtains a first input operation for any frame of the first picture.

In one embodiment, the second processing unit is configured to process the area in the multiple frames of first pictures except that satisfies the size of the first area, according to the preset processing manner, in order to preserve a dynamic display effect of the area in the multiple frames of first pictures except that satisfies the size of the first area; the preset processing manner comprises a preset data filling manner.

In one embodiment, the second processing unit is configured to determine a local area according to the previous first input operation; the previous first input operation has a closed trajectory; the temporary area is determined according to the subsequent first input operation.

In one embodiment, the first input operation obtained earliest that satisfies the closed trajectory is the previous first input operation; the first input operation after the previous first input operation is the subsequent first input operation.

Embodiments of the present disclosure provide an information processing method, comprising:
obtaining a first multimedia file, decoding the first multimedia file, and obtaining multiple frames of decoded first pictures and a time parameter of the first multimedia file
obtaining a first input operation for any selected frame of the first pictures, and determining a first area in the selected frame of the first pictures based on the first input operation;
identifying an area in each of the other frames of the first pictures except the selected frame of the first pictures corresponding to the first area of the selected frame as a first area of each of the other frames, and perform predetermined processing on areas except the first areas of the multiple frames of first pictures to generate multiple frames of second pictures; and
encoding the multiple frames of second pictures according to the time parameter to generate a second multimedia file.

In one embodiment, identifying an area in the other first picture except the any frame of the first picture corresponding to the first area and determining as a first area of the other first picture, comprising:
identifying a relative positional relationship of the first area in the any frame of the picture;
according to the relative positional relationship, determining the first area in the other frame pictures except the any frame of the first picture; the first area of the other frame pictures satisfy the relative location relationship.

In one embodiment, before obtaining the first input operation, the information processing method further comprising:
obtaining a second input operation, and determining a processing mode according to the second input operation; the processing mode comprises an incrementing mode and a deleting mode.

In one embodiment, under the condition that the processing mode is the deleting mode, obtaining a first input operation for any frame of the first picture, and determining a first area according to the first input operation, comprising:
obtaining at least two first input operations for any frame of the first picture, determining a local area according to the previous first input operation, and determining a temporary area according to a subsequent first input operation; determining the first area after deleting the temporary area from the local area.

In one embodiment, under the condition that the processing mode is the incrementing mode, obtaining a first input operation for any frame of the first picture, determining a first area according to the first input operation, comprising:
obtaining at least two first input operations for any frame of the first picture, determining a local area according to the previous first input operation, and determining a temporary area according to a subsequent first input operation; determining the combination of the local area and the temporary area as the first area.

In one embodiment, before obtaining a first input operation for any frame of the first picture, the information processing method further comprising: arranging the multiple frames of pictures in the order of the multiple frames of pictures, outputting and displaying the arranged multiple frames of pictures.

In one embodiment, performing a preset process in the area except the first area in the multiple frames of first pictures to generate a multiple frames of second pictures, comprising: according to the preset processing manner, processing the area in the multiple frames of first pictures except that satisfies the size of the first area, in order to preserve a dynamic display effect of the area in the multiple frames of first pictures except that satisfies the size of the first area; the preset processing manner comprises a preset data filling manner.

In one embodiment, determining a local area according to the previous first input operation, and determining a temporary area according to a subsequent first input operation, comprising: determining a local area according to the previous first input operation; the previous first input operation has a closed trajectory; determining a temporary area according to the subsequent first input operation.

In one embodiment, the first input operation obtained earliest that satisfies the closed trajectory is the previous first input operation; the first input operation after the previous first input operation is the subsequent first input operation.

In one embodiment, arranging the multiple frames of pictures in the order of the multiple frames of pictures, outputting and displaying the arranged multiple frames of pictures, comprising: after the first multimedia file is decoded, the multiple frames of pictures are arranged in decoding order starting from the obtained first frame picture, outputting and displaying the arranged multiple frames of pictures.

Embodiments of the present disclosure provide a computer storage medium, wherein storing computer-executable instructions configured to perform the information processing method.

Embodiments of the present disclosure provide an information processing method, a mobile terminal, and a computer storage medium. The mobile terminal includes a decoding unit, a first processing unit, a second processing unit and an encoding unit. The decoding unit is configured to obtain a first multimedia file, decode the first multimedia file, and obtain multiple frames of decoded first pictures and a time parameter of the first multimedia file; the first processing unit is configured to obtain a first input operation for any selected frame of the first pictures obtained by the decoding unit; the second processing unit is configured to identify an area in each of the other frames of the first pictures except the selected frame of the first pictures corresponding to the first area of the selected frame as a first area of each of the other frames, and perform predetermined processing on areas except the first areas of the multiple frames of first pictures to generate multiple frames of second pictures; and the encoding unit is configured to encode the multiple frames of second pictures according to the time parameter to generate a second multimedia file.

By adopting the technical solutions in the embodiments of the present invention, local processing in a dynamic picture is implemented, that is, a dynamic effect of a local area in a dynamic picture is preserved, and a static display effect is displayed except for the local area. In this way, the user's operation experience and fun is improved.

### BRIEF DESCRIPTION OF THE DRAWINGS

FIG. 1 is a block diagram of a mobile terminal according to embodiments of the present disclosure;

FIG. 2 is a block diagram of a wireless communication system of the mobile terminal shown in FIG. 1;

FIG. 3 is a structural diagram of a mobile terminal according to embodiments of the present disclosure;

FIG. 4 is a first flowchart of an information processing method according to embodiments of the present disclosure;

FIGS. 5A-5C are application schematic diagrams of an information processing method according to embodiments of the present disclosure;

FIG. 6 is a second flowchart of an information processing method according to embodiments of the present disclosure;

FIG. 7 is a schematic diagram of a deleting mode in an information processing method according to embodiments of the present disclosure;

FIG. 8 is a third flowchart of an information processing method according to embodiments of the present disclosure; and

FIG. 9 is a schematic diagram of an incrementing mode in an information processing method according to embodiments of the present disclosure.

The realization, the functions, and the advantages of the present disclosure will be further described with reference to the accompanying drawings.

### DETAILED DESCRIPTION

It should be noted that the specific embodiments described herein are only used to explain the present disclosure and are not intended to limit the present disclosure.

The mobile terminal according to embodiments of the present invention will now be described with reference to the accompanying drawings. In the following description, usage of suffixes such as ‘module’, ‘part’ or ‘unit’ used for referring to elements is given merely to facilitate explanation of the present invention, without having any significant meaning by itself. Accordingly, the ‘module’ and ‘part’ may be mixedly used.

Mobile terminals may be implemented in various forms. For example, the terminal described in the present invention may include mobile terminals such as mobile phones, smart phones, notebook computers, digital broadcast receivers, PDAs (Personal Digital Assistants), PMPs (Portable Multimedia Player), navigation devices, and the like, and fixed terminals such as digital TVs, desktop computers and the like. Hereinafter, it is assumed that the terminal is a mobile terminal. However, it would be understood by a person in the art that the configuration according to the embodiments of the present invention can be also applicable to the fixed types of terminals, except for any elements especially configured for a mobile purpose.

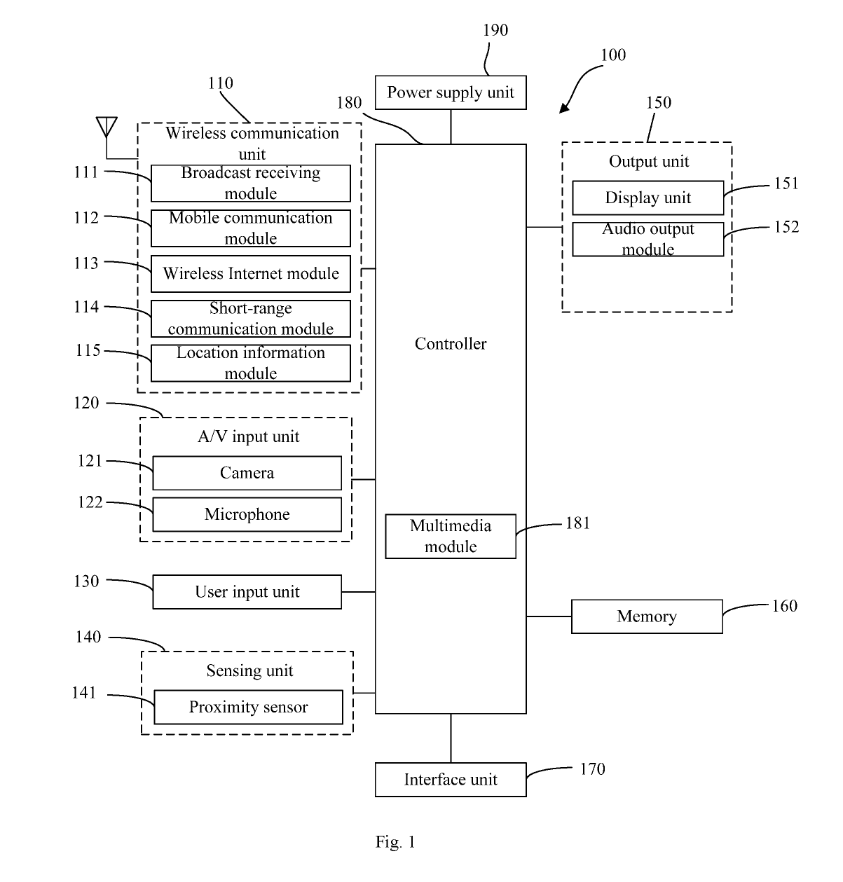

FIG. 1 is a block diagram of a mobile terminal according to the disclosed embodiment of the present invention. The mobile terminal 100 may include a wireless communication unit 110, an A/V (Audio/Video) input unit 120, a user input unit 130, a sensing unit 140, an output unit 150, a memory 160, an interface unit 170, a controller 180, a power supply unit 190 and the like. FIG. 1 shows the mobile terminal as having various components, but it should be understood that implementing all of the illustrated components is not a requirement. More or fewer components may alternatively be implemented.

The wireless communication unit 110 generally includes one or more components allowing radio communication between the mobile terminal 100 and a wireless communication system or a network. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may also be provided via a mobile communication network and, in this instance, the broadcast associated information may be received by the mobile communication module 112.

The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO@), integrated services digital broadcast-terrestrial (ISDB-T), etc. The broadcast receiving module 111 may be configured to be suitable for every broadcast system that provides a broadcast signal as well as the above-mentioned digital broadcast systems. Broadcast signals and/or broadcast-associated information received via the broadcast receiving module 111 may be stored in the memory 160 (or another type of storage medium).

The mobile communication module 112 transmits and/or receives radio signals to and/or from at least one of a base station (e.g., access point, Node B, etc.), an external terminal and a server. Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency Identification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System). According to the current technology, the GPS module 115 calculates distance information from three or more satellites and accurate time information and applies trigonometry to the calculated information to thereby accurately calculate three-dimensional current location information according to latitude, longitude, and altitude. Currently, a method for calculating location and time information by using three satellites and correcting an error of the calculated location and time information by using another one satellite. In addition, the GPS module 115 can calculate speed information by continuously calculating the current location in real time.

The A/V input unit 120 is configured to receive an audio or video signal. The A/V input unit 120 may include a camera 121 and a microphone 122. The camera 121 processes image data of still pictures or video obtained by an image capture device in a video capturing mode or an image capturing mode. The processed image frames may be displayed on a display unit 151.

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sound (audible data) via a microphone in a phone call mode, a recording mode, a voice recognition mode, and the like, and can process such sounds into audio data. The processed audio (voice) data may be converted for output into a format transmittable to a mobile communication base station via the mobile communication module 112 during the phone call mode. The microphone 122 may implement various types of noise canceling (or suppression) algorithms to cancel (or suppress) noise or interference generated in the course of receiving and transmitting audio signals.

The user input unit 130 may generate key input data from commands entered by a user to control various operations of the mobile terminal. The user input unit 130 allows the user to enter various types of information, and may include a keypad, a dome switch, a touch pad (e.g., a touch sensitive member that detects changes in resistance, pressure, capacitance, etc. due to being contacted) a jog wheel, a jog switch, and the like. In particular, when the touch pad is overlaid on the display unit 151 in a layered manner, it may form a touch screen.

The sensing unit 140 detects a current status of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor 141. This will be described in relation to a touch screen later.

The interface unit 170 serves as an interface by which at least one external device may be connected with the mobile terminal 100. For example, the external devices may include wired or wireless headset ports, an external power supply (or battery charger) ports, wired or wireless data ports, memory card ports, ports for connecting a device having an identification module, audio input/output (I/O) ports, video I/O ports, earphone ports, or the like. The identification module may be a memory chip that stores various information for authenticating a user's authority for using the mobile terminal 100 and may include a user identity module (UIM), a subscriber identity module (SIM) a universal subscriber identity module (USIM), and the like. In addition, the device having the identification module (referred to as the ‘identifying device’, hereinafter) may take the form of a smart card. Accordingly, the identifying device may be connected with the terminal 100 via a port or other connection means. The interface unit 170 may be used to receive inputs (e.g., data, information, power, etc.) from an external device and transfer the received inputs to one or more elements within the mobile terminal 100 or may be used to transfer data between the mobile terminal and an external device.

In addition, when the mobile terminal 100 is connected with an external cradle, the interface unit 170 may serve as a conduit to allow power from the cradle to be supplied therethrough to the mobile terminal 100 or may serve as a conduit to allow various command signals input from the cradle to be transferred to the mobile terminal therethrough. Various command signals or power input from the cradle may be operated as a signal for recognizing that the mobile terminal is accurately mounted on the cradle.

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, and the like.

The display unit 151 may display information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

Meanwhile, when the display unit 151 and the touch pad are overlaid in a layered manner to form a touch screen, the display unit 151 may function as both an input device and an output device. The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. Some of them may be configured to be transparent to allow viewing of the exterior, which may be called transparent displays. A typical transparent display may be, for example, a TOLED (Transparent Organic Light Emitting Diode) display, or the like. The mobile terminal 100 may include two or more display units (or other display means) according to its particular desired embodiment. For example, the mobile terminal may include both an external display unit and an internal display unit. The touch screen may be configured to detect even a touch input pressure as well as a touch input position and a touch input area.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal reception sound, a message reception sound, etc.). The audio output module 152 may include a speaker, a buzzer, or the like.

The alarm unit 153 may provide outputs to inform about the occurrence of an event of the mobile terminal 100. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations. When a call, a message, or some other incoming communication is received, the alarm unit 153 may provide tactile outputs (i.e., vibrations) to inform the user thereof. By providing such tactile outputs, the user can recognize the occurrence of various events even if his mobile phone is in the user's pocket. Outputs informing about the occurrence of an event may be also provided via the display unit 151 or the audio output module 152.

The memory 160 may store software programs or the like used for the processing and controlling operations performed by the controller 180, or may temporarily store data (e.g., a phonebook, messages, still images, video, etc.) that have been outputted or are to be outputted. Also, the memory 160 may store data regarding various patterns of vibrations and audio signals output when a touch is applied to the touch screen.

The memory 160 may include at least one type of storage medium including a Flash memory, a hard disk, a multimedia card, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like. Also, the mobile terminal 100 may cooperate with a network storage device that performs the storage function of the memory 160 over a network connection.

The controller 180 typically controls the general operations of the mobile terminal. For example, the controller 180 performs controlling and processing associated with voice calls, data communications, video calls, and the like. In addition, the controller 180 may include a multimedia module 181 for reproducing (or playing back) multimedia data. The multimedia module 181 may be configured within the controller 180 or may be configured to be separate from the controller 180. The controller 180 may perform a pattern recognition processing to recognize a handwriting input or a picture drawing input performed on the touch screen as characters or images.

The power supply unit 190 receives external power or internal power and supplies appropriate power required for operating respective elements and components under the control of the controller 180.

Various embodiments as described herein may be implemented in a computer-readable medium using, for example, computer software, hardware, or any combination thereof. For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some instances, such embodiments may be implemented in the controller 180. For software implementation, the embodiments such as procedures or functions may be implemented together with separate software modules that allow performing of at least one function or operation. Software codes can be implemented by a software application (or program) written in any suitable programming language. The software codes may be stored in the memory 160 and executed by the controller 180.

So far, the mobile terminal has been described from the perspective of its functions. Hereinafter, a slide-type mobile terminal, among various types of mobile terminal such as folder-type, bar-type, swing-type, slide type mobile terminals, or the like, will be described as an example for the sake of brevity. Thus, the present invention can be applicable to any type of mobile terminal, without being limited to the slide-type mobile terminal.

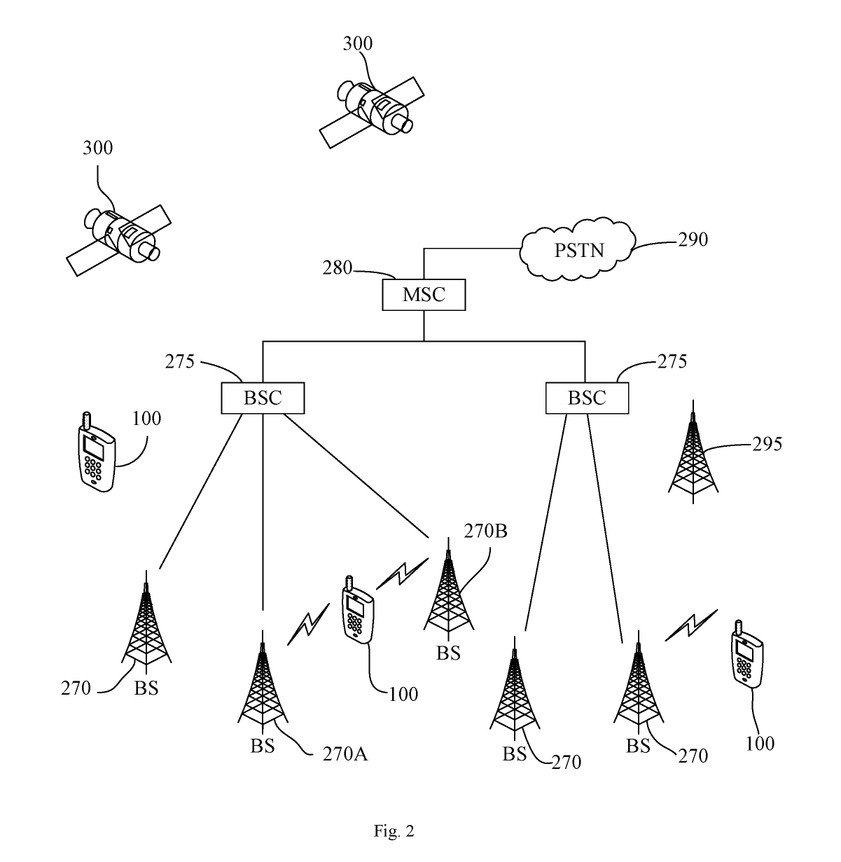

The mobile terminal 100 as shown in FIG. 1 may be configured to operate with a communication system, which transmits data via frames or packets, such as wired and wireless communication systems, as well as satellite-based communication systems. Such communication systems in which the mobile terminal according to an embodiment of the present invention can operate will now be described with reference to FIG. 2. These communication systems may use different air interfaces and/or physical layers. For example, air interfaces utilized by the communication systems include example, frequency division multiple access (FDMA), time division multiple access (TDMA), code division multiple access (CDMA), and universal mobile telecommunications system (UMTS) (in particular, long term evolution (LTE)), global system for mobile communications (GSM), and the like. As a non-limiting example, the description hereafter relates to a CDMA communication system, but such teachings apply equally to other types of systems.

Referring to FIG. 2, a CDMA wireless communication system may include a plurality of mobile terminals 100, a plurality of base stations (BSs) 270, base station controllers (BSCs) 275, and a mobile switching center (MSC) 280. The MSC 280 is configured to interface with a public switch telephone network (PSTN) 290. The MSC 280 is also configured to interface with the BSCs 275, which may be coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system as shown in FIG. 2 may include a plurality of BSCs 275.

Each BS 270 may serve one or more sectors (or regions), each sector covered by an omni-directional antenna or an antenna pointed in a particular direction radially away from the BS 270. Alternatively, each sector may be covered by two or more antennas for diversity reception. Each BS 270 may be configured to support a plurality of frequency assignments, and each frequency assignment has a particular spectrum (e.g., 1.25 MHz, 5 MHz, etc.).

The intersection of a sector and frequency assignment may be referred to as a CDMA channel. The BS 270 may also be referred to as base station transceiver subsystems (BTSs) or other equivalent terms. In this situation, the term “base station” may be used to collectively refer to a single BSC 275 and at least one BS 270. The base station may also be referred to as a “cell site”. Alternatively, individual sectors of a particular BS 270 may be referred to as a plurality of cell sites.

As shown in FIG. 2, a broadcasting transmitter (BT) 295 transmits a broadcast signal to the mobile terminals 100 operating within the system. The broadcast receiving module 111 as shown in FIG. 1 is provided at the terminal 100 to receive broadcast signals transmitted by the BT 295. In FIG. 2, several global positioning systems (GPS) satellites 300 are shown. The satellites 300 help locate at least one of a plurality of terminals 100.

In FIG. 2, several satellites 300 are depicted, but it is understood that useful positioning information may be obtained with any number of satellites. The GPS module 115 as shown in FIG. 1 is typically configured to cooperate with the satellites 300 to obtain desired positioning information. Instead of or in addition to GPS tracking techniques, other technologies that may track the location of the mobile terminals may be used. In addition, at least one of the GPS satellites 300 may selectively or additionally handle satellite DMB transmissions.

As one typical operation of the wireless communication system, the BSs 270 receive reverse-link signals from various mobile terminals 100. The mobile terminals 100 typically engaging in calls, messaging, and other types of communications. Each reverse-link signal received by a particular base station 270 is processed within the particular BS 270. The resulting data is forwarded to an associated BSC 275. The BSC provides call resource allocation and mobility management functionality including the coordination of soft handoff procedures between BSs 270. The BSCs 275 also route the received data to the MSC 280, which provides additional routing services for interfacing with the PSTN 290. Similarly, the PSTN 290 interfaces with the MSC 280, the MSC interfaces with the BSCs 275, and the BSCs 275 in turn control the BSs 270 to transmit forward-link signals to the mobile terminals 100.

Based on the above mobile terminal hardware structure and communication system, various embodiments of the method of the present disclosure are proposed.

### Embodiment 1

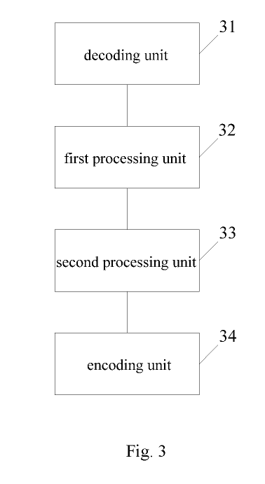

Embodiments of the present disclosure provide a mobile terminal. FIG. 3 is a structural diagram of a mobile terminal according to embodiments of the present disclosure; referring to FIG. 3, the mobile terminal includes a decoding unit 31, a first processing unit 32, a second processing unit 33, and an encoding unit 34.

The decoding unit 31 is configured to obtain a first multimedia file, decode the first multimedia file, obtain multiple frames of decoded first pictures, and a time parameter of the first multimedia file.

The first processing unit 32 is configured to obtain a first input operation for any selected frame of the first pictures obtained by the decoding unit 31.

The second processing unit 33 is configured to determine a first area in the selected frame of the first pictures based on the first input operation obtained by the first processing unit 32; identify an area in each of the other first pictures except the selected frame of the first pictures corresponding to the first area of the selected frame and determine the area as the first area of each of the other first pictures, and perform predetermined processing on areas except the first areas of the multiple frames of first pictures to generate multiple frames of second pictures.

The encoding unit 34 is configured to encode the multiple frames of second pictures according to the time parameter to generate a second multimedia file.

In this embodiment, the mobile terminal can specifically be a smart phone, a tablet computer, and so on.

The multimedia files (including the first multimedia file and the second multimedia file) described in this embodiment may include an image file. In one embodiment, the image file can be a dynamic-effect picture file. Specifically, the image file can be a GIF (Graphics Interchange Format) file; and, in other embodiments, the image file can also be any image file with dynamic effect.

After obtaining the first multimedia file, the decoding unit 31 decodes the first multimedia file, according to a preset decoding format, so as to obtain the multiple frames of pictures included in the multimedia file and the time parameter of the first multimedia file. The time parameter indicates the time interval between two adjacent picture frames in the multiple frames of pictures. As for the decoding method, reference can be made to any decoding method in the current technology that matches the type of the first multimedia file, which is not described in this embodiment. Since the first multimedia file (image file) is generated from a plurality of frames of pictures according to a preset time parameter, if the time parameter is sufficiently less (for example, less than 0.5 second), the first multimedia file can be displayed with a dynamic effect.

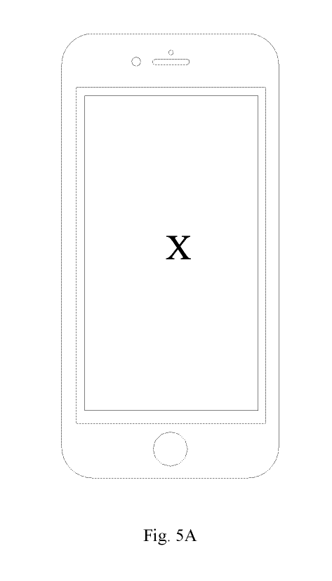

In one embodiment, the mobile terminal further includes a display unit, and the display unit may be configured to, before the first processing unit 32 obtains the first input operation by decoding unit 31 for any frame of the first pictures, arrange the multiple frames of pictures in the order of the multiple frames of pictures, and output and display the arranged multiple frames of pictures. In one embodiment, referring to FIG. 5A, after the first multimedia file is decoded, decoded frame pictures are sequentially displayed starting from the first one. The frames of pictures can be sequentially displayed at a preset time interval, or can also be sequentially displayed based on the input operation. For example, when the mobile terminal detects a slide gesture operation that is indicative of page turning, the next picture frame following the current one may be displayed. In FIG. 5A, X indicates that any picture in the N frames obtained after decoding the first multimedia file; X and N are positive integers, and X is less than or equal to N.

In this embodiment, the first input operation is an input operation for any frame in the multiple frames of first pictures. When the frame picture is outputted as shown in FIG. 5A, the first input operation may be input operation for picture X. Further, the first input operation is identified, and the first area of the frame can be obtained according to the first input operation. For specific reference, as shown in FIG. 5B, the first area a1 is determined according to the first input operation of the picture X.

In this embodiment, the second processing unit 33 is configured to identify a relative position relationship of the first area in the selected frame and, according to the relative positional relationship, determine the first areas in the other frames of pictures except the selected frame of the first pictures. The first areas of the other frames of pictures satisfy the relative location relationship.

Specifically, referring to FIG. 5B, the second processing unit 33 identifies the relative position relationship of the first region a1 in the selected frame of pictures, determines the areas in other frames of pictures except the selected frame of the pictures that satisfy the relative position relationship, that is, the areas in the other frames of pictures match the relative position relationship. Thus, after determining the first area of the any selected frame of the first pictures based on the first input operation, the areas of other frames of the first pictures matching the first area are determined at the same time. Specifically, as shown in FIG. 5C, when the first area a1 of the first picture a is determined based on the first input operation, the area b1 corresponding to the relative position relationship is determined in the picture b, the area c1 corresponding to the relative position relationship is determined in the picture c, and the area d1 corresponding to the relative position relationship is determined in the picture d. Further, the second processing unit 33 processes, based on a preset processing format, the areas in the multiple frames of first pictures except those satisfying the size of the first area. The present processing format may be filling a preset data (such as black data), such that only the dynamic effect of the first areas in the multiple frames of first pictures is preserved, and other areas except the first areas are displayed through the static display effect, generating multiple frames of second pictures. That is, it can be understood that the dynamic display effect is preserved only for the local area in each frame of pictures in the first multimedia file, and the local areas in the frames of pictures are of the same size and the same relative positions.

The encoding unit 34 encodes, according to a time parameter obtained in advance, the obtained multiple frames of the second pictures using a preset encoding format, so as to obtain the second multimedia file. As for the encoding method, reference can be made to any encoding method in the current technology that matches the type of the first multimedia file, which is not repeated in this embodiment.

By adopting the technical solutions in the embodiments of the present invention, local processing in a dynamic picture is realized, that is, the dynamic effect of local areas in the dynamic picture is preserved, and the static display effect is used to display other areas except for the local areas. Thus, the user operating experience and fun can be improved.

### Embodiment 2

Embodiments of the present disclosure provide a mobile terminal. Referring to FIG. 3, the mobile terminal includes a decoding unit 31, a first processing unit 32, a second processing unit 33, and an encoding unit 34.

The decoding unit 31 is configured to obtain a first multimedia file, decode the first multimedia file, obtain multiple frames of decoded first pictures, and a time parameter of the first multimedia file.

The first processing unit 32 is configured to obtain a second input operation, and to determine a processing mode according to the second input operation. The processing mode may include an incrementing mode and a deleting mode. Further, the first processing unit is also configured to obtain a first input operation for any selected frame of the first pictures obtained by the decoding unit 31.

The second processing unit 33 is configured to, when the processing mode is the deleting mode, obtain at least two first input operations for any selected frame of the first pictures, determine a local area according to the first-obtained first input operation, and determine a temporary area according to a subsequently-obtained first input operation. Further, the second processing unit 33 is configured to determine a first area as the local area after deleting the temporary area from the local area, to identify a relative positional relationship of the first area in the selected frame of the pictures, to determine first areas in the other frames of the pictures except the selected frame of the pictures according to the relative positional relationship, where the first area of the other frames of the pictures satisfy the relative location relationship, and to perform predetermined processing on areas except the first areas of the multiple frames of first pictures to generate multiple frames of second pictures.

The encoding unit 34 is configured to encode the multiple frames of second pictures according to the time parameter to generate a second multimedia file.

In this embodiment, the mobile terminal can specifically be a smart phone, a tablet computer, and so on.

The multimedia files (including the first multimedia file and the second multimedia file) described in this embodiment may include an image file. In one embodiment, the image file can be a dynamic-effect picture file. Specifically, the image file can be a GIF (Graphics Interchange Format) file; and, in other embodiments, the image file can also be any image file with dynamic effect.

After obtaining the first multimedia file, the decoding unit 31 decodes the first multimedia file, according to a preset decoding format, so as to obtain the multiple frames of pictures included in the multimedia file and the time parameter of the first multimedia file. The time parameter indicates the time interval between two adjacent picture frames in the multiple frames of pictures. As for the decoding method, reference can be made to any decoding method in the current technology that matches the type of the first multimedia file, which is not described in this embodiment. Since the first multimedia file (image file) is generated from a plurality of frames of pictures according to a preset time parameter, if the time parameter is sufficiently less (for example, less than 0.5 second), the first multimedia file can be displayed with a dynamic effect.

In one embodiment, the mobile terminal further includes a display unit, and the display unit may be configured to, before the first processing unit 32 obtains the first input operation by decoding unit 31 for any frame of the first pictures, arrange the multiple frames of pictures in the order of the multiple frames of pictures, and output and display the arranged multiple frames of pictures. In one embodiment, referring to FIG. 5A, after the first multimedia file is decoded, decoded frame pictures are sequentially displayed starting from the first one. The frames of pictures can be sequentially displayed at a preset time interval, or can also be sequentially displayed based on the input operation. For example, when the mobile terminal detects a slide gesture operation that is indicative of page turning, the next picture frame following the current one may be displayed. In FIG. 5A, X indicates that any picture in the N frames obtained after decoding the first multimedia file; X and N are positive integers, and X is less than or equal to N.

In this embodiment, the first input operation is an input operation for any frame in the multiple frames of first pictures. When the frame picture is outputted as shown in FIG. 5A, the first input operation may be input operation for picture X. Further, the first input operation is identified, and the first area of the frame can be obtained according to the first input operation. For specific reference, as shown in FIG. 5B, the first area a1 is determined according to the first input operation of the picture X.

In this embodiment, at least two processing modes are pre-configured in the mobile terminal, and the processing mode includes at least an incrementing mode and a deleting mode. The processing mode is triggered based on an input operation (i.e., the second input operation). In this embodiment, the time point at which the processing mode is triggered is not specifically limited.

This embodiment specifically describes that the processing mode is the deleting mode. Specifically, when the processing mode is the deleting mode, at least two first input operations are obtained by the mobile terminal. In one embodiment, taking two first input operations as an example, the operation trajectory of the first-obtained first input operation is a closed trajectory, such as a closed circle, and the operation trajectory of the first-obtained first input operation with a closed trajectory is determined as the local area. The operation trajectory of the subsequently-obtained first input operation is not limited to whether the operation trajectory is closed or not, and the temporary area is determined according to the subsequently-obtained first input operation. That is, when there are at least two first input operations, the local area is determined by the earliest first input operation that has a closed operation trajectory, all other first input operations are subsequently-obtained first input operations, which is not limited to whether the operation trajectory is closed or not, and the temporary area is determined based on the operation trajectory of the subsequently-obtained first input operation.

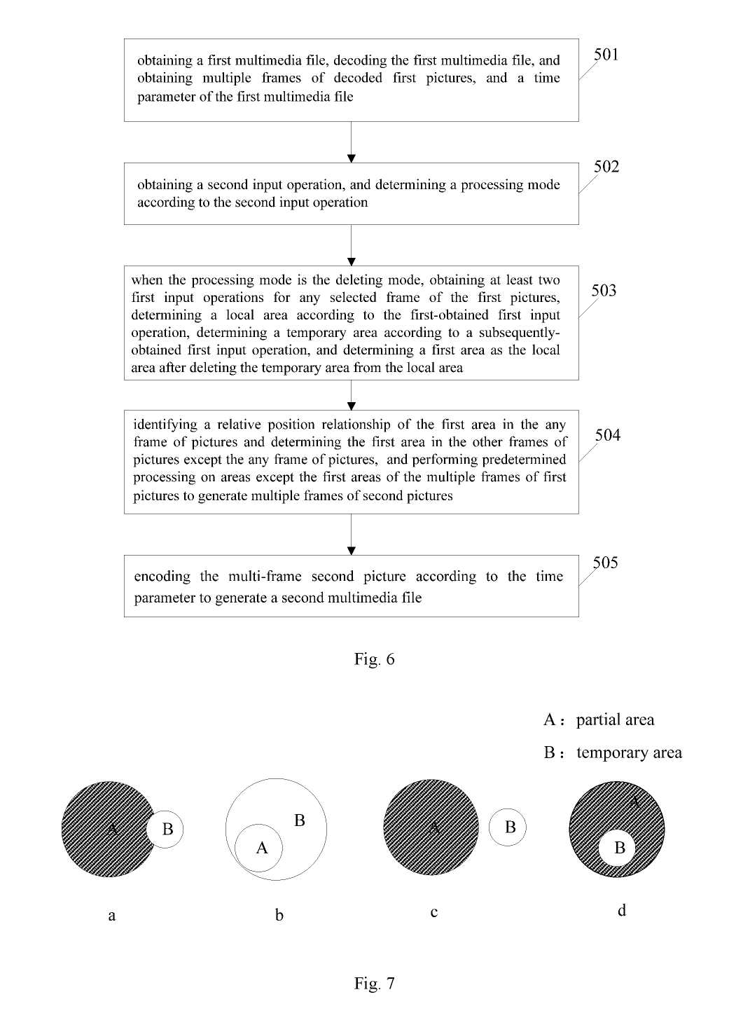

In this embodiment, since the processing mode is the deleting mode, the first area is determined after deleting the temporary area from the local area. As shown in FIG. 7, A represents a local area, B represents a temporary area, and a shaded area represents a first area obtained. As shown in FIG. 7, four application scenarios are listed; Scenario a in FIG. 7 indicates when the local area and the temporary area overlap, a first area obtained is equivalent to deleting the overlapping area. Scenario b in FIG. 7 indicates when the local area is smaller than the temporary area, and the temporary area completely covers the local area. The first area obtained is equivalent to “empty”. Scenario c in FIG. 7 indicates that the local area and the temporary area do not overlap, so the first area obtained is the local area. Scenario d in FIG. 7 indicates that the local area overlaps with the temporary area, the temporary area is smaller than the local area, and the local area covers the temporary area. The first area obtained is equivalent to the area that deleting the temporary area from the local area.

In one embodiment, the second processing unit 33 is configured to identify a relative position relationship of the first area in the any frame of pictures and, according to the relative positional relationship, determine the first area in the other frames of pictures except the any frame of pictures. The first area of the other frames of pictures satisfy the relative location relationship.

Specifically, referring to FIG. 5B, the second processing unit 33 identifies the relative position relationship of the first area a1 in the any selected frame of pictures and, according to the relative positional relationship, determine areas satisfying the relative position relationship in the other frames of pictures except the selected frame of pictures. That is, based on the relative positional relationship, to determine the areas in the other frames of pictures match the relative position relationship, such that, after determining the first area of the any selected frame of the first pictures based on the first input operation, the areas of other frames of the first pictures matching the first area are determined at the same time. Specifically, as shown in FIG. 5C, when the first area a1 of the first picture a is determined based on the first input operation, the area b1 corresponding to the relative position relationship is determined in the picture b, the area c1 corresponding to the relative position relationship is determined in the picture c, and the area d1 corresponding to the relative position relationship is determined in the picture d. Further, the second processing unit 33 processes, based on a preset processing format, the areas in the multiple frames of first pictures except those satisfying the size of the first area. The present processing format may be filling a preset data (such as black data), such that only the dynamic effect of the first areas in the multiple frames of first pictures is preserved, and other areas except the first areas are displayed through the static display effect, generating multiple frames of second pictures. That is, it can be understood that the dynamic display effect is preserved only for the local area in each frame of pictures in the first multimedia file, and the local areas in the frames of pictures are of the same size and the same relative positions.

In one embodiment, the encoding unit 34 encodes the obtained multiple frames of second pictures using a preset encoding format, according to a time parameter obtained in advance, to obtain the second multimedia file. As for the encoding method, reference can be made to any encoding method in the current technology that matches the type of the first multimedia file, which is not described in this embodiment.

By adopting the technical solutions in the embodiments of the present invention, on one hand, local processing in a dynamic picture is realized, that is, the dynamic effect of local areas in the dynamic picture is preserved, and the static display effect is used to display other areas except for the local areas. On the other hand, the addition of the processing mode (deleting mode) facilitates operation by the user in the image processing. Thus, the user operating experience and fun can be improved.

### Embodiment 3

Embodiments of the present disclosure provide a mobile terminal. Referring to FIG. 3, the mobile terminal includes a decoding unit 31, a first processing unit 32, a second processing unit 33, and an encoding unit 34.

The decoding unit 31 is configured to obtain a first multimedia file, decode the first multimedia file, obtain multiple frames of decoded first pictures, and a time parameter of the first multimedia file;

The first processing unit 32 is configured to obtain a second input operation, and to determine a processing mode according to the second input operation. The processing mode may include an incrementing mode and a deleting mode. Further, the first processing unit is also configured to obtain a first input operation for any selected frame of the first pictures obtained by the decoding unit 31.

The second processing unit 33 is configured to, when the processing mode is the incrementing mode, obtain at least two first input operations for any selected frame of the first pictures, determine a local area according to the first-obtained first input operation, and determine a temporary area according to a subsequently-obtained first input operation. Further, the second processing unit 33 is configured to determine a first area as the local area after combining the temporary area from the local area, to identify a relative positional relationship of the first area in the selected frame of the pictures, to determine first areas in the other frames of the pictures except the selected frame of the pictures according to the relative positional relationship, where the first area of the other frames of the pictures satisfy the relative location relationship, and to perform predetermined processing on areas except the first areas of the multiple frames of first pictures to generate multiple frames of second pictures.

The encoding unit 34 is configured to encode the multiple frames of second pictures according to the time parameter to generate a second multimedia file.

This embodiment is similar to above described Embodiment 2 except that the processing mode in this embodiment is an incrementing mode. In one embodiment, at least two first input operations are obtained by the mobile terminal. In one embodiment, using two first input operations as an example, the operation trajectory of the first-obtained first input operation is a closed trajectory, such as a closed circle, and the operation trajectory of the first-obtained first input operation with a closed trajectory is determined as the local area. The operation trajectory of the subsequently-obtained first input operation is not limited to whether the operation trajectory is closed or not, and the temporary area is determined according to the subsequently-obtained first input operation. That is, when there are at least two first input operations, the local area is determined by the earliest first input operation that has a closed operation trajectory, all other first input operations are subsequently-obtained first input operations, which is not limited to whether the operation trajectory is closed or not, and the temporary area is determined based on the operation trajectory of the subsequently-obtained first input operation

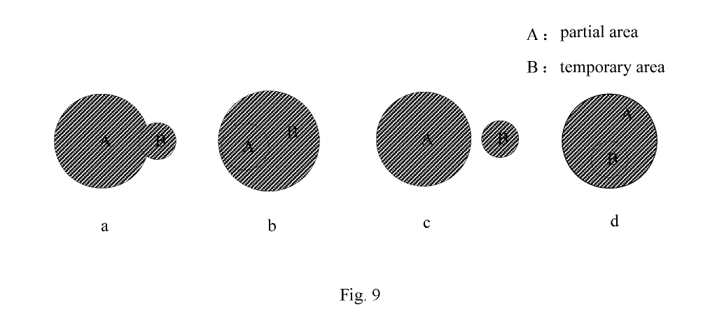

In this embodiment, since the processing mode is the incrementing mode, the combination of the local area and the temporary area is determined as the first area. As shown in FIG. 9, A represents a local area, B represents a temporary area, and a shaded area represents a first area obtained. As shown in FIG. 9, four application scenarios are listed. Scenario a in FIG. 9 indicates when the local area and the temporary area overlap, a first area obtained is equivalent to the local area and the temporary area being added together. Scenario b in FIG. 9 indicates when the local area is smaller than the temporary area, and the temporary area completely covers the local area. The first area obtained is equivalent to the temporary area. Scenario c in FIG. 9 indicates that the local area and the temporary area do not overlap, so the first area obtained is the local area and the temporary area added together. Scenario d in FIG. 9 indicates that the local area overlaps with the temporary area, the temporary area is smaller than the local area, and the local area covers the temporary area. The first area obtained is equivalent to the local area.

By adopting the technical solutions in the embodiments of the present invention, on one hand, local processing in a dynamic picture is implemented, that is, a dynamic effect of a local area in a dynamic picture is preserved, and a static display effect is displayed except for the local area. On the other hand, the addition of the processing mode (incrementing mode) facilitates the user in the image processing operation, which improve the user's operating experience and fun.

In Embodiments 1-3 of the present disclosure, the decoding unit 31, the first processing unit 32, the second processing unit 33, and the encoding unit 34 in the mobile terminal all can be realized by Central Processing Unit (CPU), a Digital Signal Processor (DSP), or a Field-Programmable Gate Array (FPGA) in the mobile terminal.

### Embodiment 4

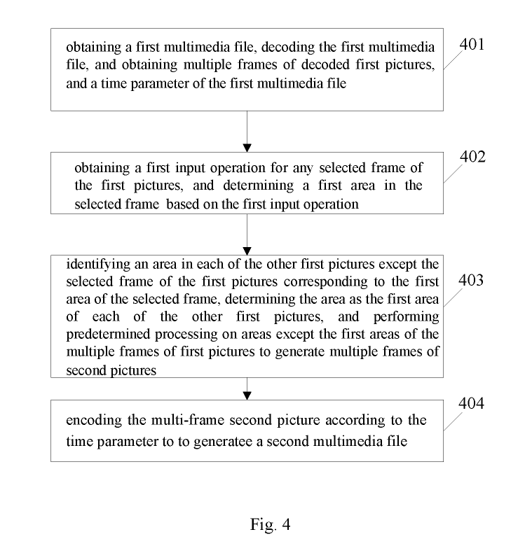

Embodiments of the present disclosure provide an information method. FIG. 4 is a first flowchart of an information processing method according to embodiments of the present disclosure. Referring to FIG. 4, the information processing method includes the followings.

Step 401: obtaining a first multimedia file, decoding the first multimedia file, and obtaining multiple frames of decoded first pictures, and a time parameter of the first multimedia file.

In this embodiment, the information processing method is applied to a mobile terminal. The mobile terminal can specifically be a smart phone, a tablet computer and so on. Of course, the information processing method may also be applied to a fixed terminal such as a personal computer (PC). Taking a mobile terminal as an example, the executing entity of each step in this embodiment is the mobile terminal.

The multimedia file (including the first multimedia file in Step 401 and the second multimedia file in Step 404) described in this embodiment may include an image file. In one embodiment, the image file can be a dynamic-effect picture file. Specifically, the image file can be a GIF (Graphics Interchange Format) file; and, in other embodiments, the image file can also be any image file with dynamic effect.

Here, after obtaining the first multimedia file, the first multimedia file is decoded according to a preset decoding format, so as to obtain the multiple frames of pictures included in the multimedia file and the time parameter of the first multimedia file. The time parameter indicates the time interval between two adjacent picture frames in the multiple frames of pictures. As for the decoding method, reference can be made to any decoding method in the current technology that matches the type of the first multimedia file, which is not described in this embodiment. Since the first multimedia file (image file) is generated from a plurality of frames of pictures according to a preset time parameter, if the time parameter is sufficiently less (for example, less than 0.5 second), the first multimedia file can be displayed with a dynamic effect.

Step 402: obtaining a first input operation for any selected frame of the first pictures, and determining a first area in the selected frame of the first pictures based on the first input operation.

In this embodiment, before obtaining a first input operation for any selected frame of the first pictures, the method further comprising: arranging the multiple frames of pictures in the order of the multiple frames of pictures, and outputting and displaying the arranged multiple frames of pictures. In one embodiment, referring to FIG. 5A, after the first multimedia file is decoded, decoded frame pictures are sequentially displayed starting from the first one. The frames of pictures can be sequentially displayed at a preset time interval, or can also be sequentially displayed based on the input operation. For example, when the mobile terminal detects a slide gesture operation that is indicative of page turning, the next picture frame following the current one may be displayed. In FIG. 5A, X indicates that any picture in the N frames obtained after decoding the first multimedia file; X and N are positive integers, and X is less than or equal to N.

In this embodiment, the first input operation is an input operation for any frame in the multiple frames of first pictures. When the frame picture is outputted as shown in FIG. 5A, the first input operation may be input operation for picture X. Further, the first input operation is identified, and the first area of the frame can be obtained according to the first input operation. For specific reference, as shown in FIG. 5B, the first area a1 is determined according to the first input operation of the picture X.

Step 403: identifying an area in each of the other first pictures except the selected frame of the first pictures corresponding to the first area of the selected frame, determining the area as the first area of each of the other first pictures, and performing predetermined processing on areas except the first areas of the multiple frames of first pictures to generate multiple frames of second pictures.

Here, the process of identifying the areas in the multiple frames of the first pictures with the areas corresponding to the first area of the selected frame and generating multiple frames of second pictures based on the multiple frames of first pictures includes: identifying a relative position relationship of the first area in the selected frame and, according to the relative positional relationship, determining the first areas in the other frames of pictures except the selected frame of the first pictures. The first areas of the other frames of pictures satisfy the relative location relationship.

Specifically, referring to FIG. 5B, the relative position relationship of the first region a1 in the selected frame of pictures is identified, and the areas in other frames of pictures except the selected frame of the pictures that satisfy the relative position relationship are determined. That is, the areas in the other frames of pictures match the relative position relationship. Thus, after determining the first area of the any selected frame of the first pictures based on the first input operation, the areas of other frames of the first pictures matching the first area are determined at the same time. Specifically, as shown in FIG. 5C, when the first area a1 of the first picture a is determined based on the first input operation, the area b1 corresponding to the relative position relationship is determined in the picture b, the area c1 corresponding to the relative position relationship is determined in the picture c, and the area d1 corresponding to the relative position relationship is determined in the picture d. Further, based on a preset processing format, the areas in the multiple frames of first pictures except those satisfying the size of the first area are processed. The present processing format may be filling a preset data (such as black data), such that only the dynamic effect of the first areas in the multiple frames of first pictures is preserved, and other areas except the first areas are displayed through the static display effect, generating multiple frames of second pictures. That is, it can be understood that the dynamic display effect is preserved only for the local area in each frame of pictures in the first multimedia file, and the local areas in the frames of pictures are of the same size and the same relative positions.

Step 404: encoding the multiple frames of second pictures according to the time parameter to generate a second multimedia file.

Here, the mobile terminal encodes the obtained multiple frames of second pictures using a preset encoding format, according to a time parameter obtained in Step 401 in advance, so as to obtain the second multimedia file. As for the encoding method, reference can be made to any encoding method in the current technology that matches the type of the first multimedia file, which is not repeated in this embodiment.

By adopting the technical solutions in the embodiments of the present invention, local processing in a dynamic picture is realized, that is, the dynamic effect of local areas in the dynamic picture is preserved, and the static display effect is used to display other areas except for the local areas. Thus, the user operating experience and fun can be improved.

### Embodiment 5

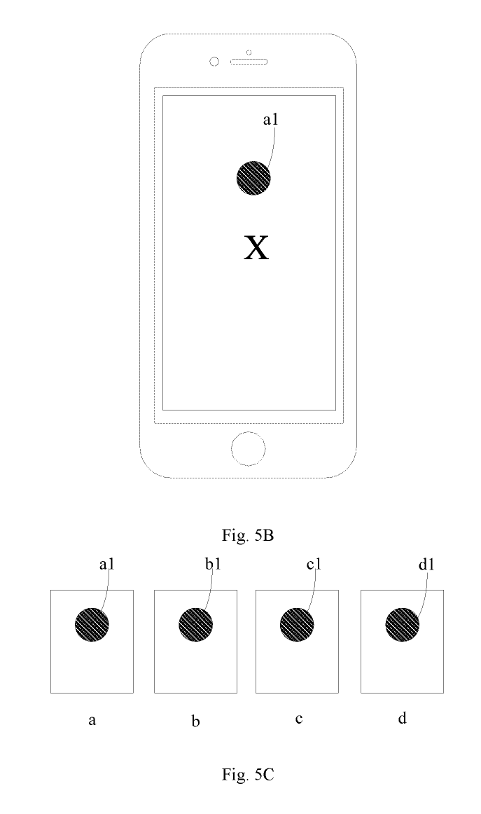

Embodiments of the present disclosure provide an information method. FIG. 6 is a second flowchart of an information processing method according to embodiments of the present disclosure. Referring to FIG. 6, the information processing method includes the followings.

Step 501: obtaining a first multimedia file, decoding the first multimedia file, and obtaining multiple frames of decoded first pictures, and a time parameter of the first multimedia file.

In this embodiment, the information processing method is applied to a mobile terminal. The mobile terminal can specifically be a smart phone, a tablet computer and so on. Of course, the information processing method may also be applied to a fixed terminal such as a personal computer (PC). Taking a mobile terminal as an example, the executing entity of each step in this embodiment is the mobile terminal.

The multimedia file (including the first multimedia file in Step 401 and the second multimedia file in Step 404) described in this embodiment may include an image file. In one embodiment, the image file can be a dynamic-effect picture file. Specifically, the image file can be a GIF (Graphics Interchange Format) file; and, in other embodiments, the image file can also be any image file with dynamic effect.

Here, after obtaining the first multimedia file, the first multimedia file is decoded according to a preset decoding format, so as to obtain the multiple frames of pictures included in the multimedia file and the time parameter of the first multimedia file. The time parameter indicates the time interval between two adjacent picture frames in the multiple frames of pictures. As for the decoding method, reference can be made to any decoding method in the current technology that matches the type of the first multimedia file, which is not described in this embodiment. Since the first multimedia file (image file) is generated from a plurality of frames of pictures according to a preset time parameter, if the time parameter is sufficiently less (for example, less than 0.5 second), the first multimedia file can be displayed with a dynamic effect.

Step 502: obtaining a second input operation, and determining a processing mode according to the second input operation; the processing mode comprises an incrementing mode and a deleting mode.

In this embodiment, at least two processing modes are pre-configured in the mobile terminal, and the processing mode includes at least an incrementing mode and a deleting mode; and the processing mode is triggered based on an input operation (i.e., a second input operation). In this embodiment, the point of time at which the processing mode is triggered is not specifically limited in the current step, and may be performed before step 501 or after step 503. This embodiment does not intend to be limiting.

Step 503: when the processing mode is the deleting mode, obtaining at least two first input operations for any selected frame of the first pictures, determining a local area according to the first-obtained first input operation, determining a temporary area according to a subsequently-obtained first input operation, and determining a first area as the local area after deleting the temporary area from the local area.

This embodiment specifically describes that the processing mode is the deleting mode. Specifically, when the processing mode is the deleting mode, at least two first input operations are obtained by the mobile terminal. In one embodiment, taking two first input operations as an example, the operation trajectory of the first-obtained first input operation is a closed trajectory, such as a closed circle, and the operation trajectory of the first-obtained first input operation with a closed trajectory is determined as the local area. The operation trajectory of the subsequently-obtained first input operation is not limited to whether the operation trajectory is closed or not, and the temporary area is determined according to the subsequently-obtained first input operation. That is, when there are at least two first input operations, the local area is determined by the earliest first input operation that has a closed operation trajectory, all other first input operations are subsequently-obtained first input operations, which is not limited to whether the operation trajectory is closed or not, and the temporary area is determined based on the operation trajectory of the subsequently-obtained first input operation.

In this embodiment, since the processing mode is the deleting mode, the first area is determined after deleting the temporary area from the local area. FIG. 7 illustrates a schematic of a deleting mode in the information processing method according to embodiments of the present disclosure. As shown in FIG. 7, A represents a local area, B represents a temporary area, and a shaded area represents a first area obtained. As shown in FIG. 7, four application scenarios are listed. Scenario a in FIG. 7 indicates when the local area and the temporary area overlap, a first area obtained is equivalent to deleting the overlapping area. Scenario b in FIG. 7 indicates when the local area is smaller than the temporary area, and the temporary area completely covers the local area. The first area obtained is equivalent to “empty”. Scenario c in FIG. 7 indicates that the local area and the temporary area do not overlap, so the first area obtained is the local area. Scenario d in FIG. 7 indicates that the local area overlaps with the temporary area, the temporary area is smaller than the local area, and the local area covers the temporary area. The first area obtained is equivalent to the area that deleting the temporary area from the local area.

Step 504: identifying a relative position relationship of the first area in the any frame of pictures and, according to the relative positional relationship, determining the first area in the other frames of pictures except the any frame of pictures, where the first area of the other frames of pictures satisfy the relative location relationship, and performing predetermined processing on areas except the first areas of the multiple frames of first pictures to generate multiple frames of second pictures.

Specifically, referring to FIG. 5B, the relative position relationship of the first area a1 in the any selected frame of pictures is identified and, according to the relative positional relationship, areas satisfying the relative position relationship in the other frames of pictures except the selected frame of pictures are determined. That is, based on the relative positional relationship, to determine the areas in the other frames of pictures match the relative position relationship, such that, after determining the first area of the any selected frame of the first pictures based on the first input operation, the areas of other frames of the first pictures matching the first area are determined at the same time. Specifically, as shown in FIG. 5C, when the first area a1 of the first picture a is determined based on the first input operation, the area b1 corresponding to the relative position relationship is determined in the picture b, the area c1 corresponding to the relative position relationship is determined in the picture c, and the area d1 corresponding to the relative position relationship is determined in the picture d. Further, based on a preset processing format, the areas in the multiple frames of first pictures except those satisfying the size of the first area are processed. The present processing format may be filling a preset data (such as black data), such that only the dynamic effect of the first areas in the multiple frames of first pictures is preserved, and other areas except the first areas are displayed through the static display effect, generating multiple frames of second pictures. That is, it can be understood that the dynamic display effect is preserved only for the local area in each frame of pictures in the first multimedia file, and the local areas in the frames of pictures are of the same size and the same relative positions.

Step 505: encoding the multiple frames of second pictures according to the time parameter to generate a second multimedia file.

The mobile terminal encodes the obtained multiple frames of second pictures using a preset encoding format, according to a time parameter obtained in Step 501 in advance, so as to obtain the second multimedia file. As for the encoding method, reference can be made to any encoding method in the current technology that matches the type of the first multimedia file, which is not repeated in this embodiment.

By adopting the technical solutions in the embodiments of the present invention, on one hand, local processing in a dynamic picture is realized, that is, the dynamic effect of local areas in the dynamic picture is preserved, and the static display effect is used to display other areas except for the local areas. On the other hand, the addition of the processing mode (deleting mode) facilitates operation by the user in the image processing. Thus, the user operating experience and fun can be improved.

### Embodiment 6

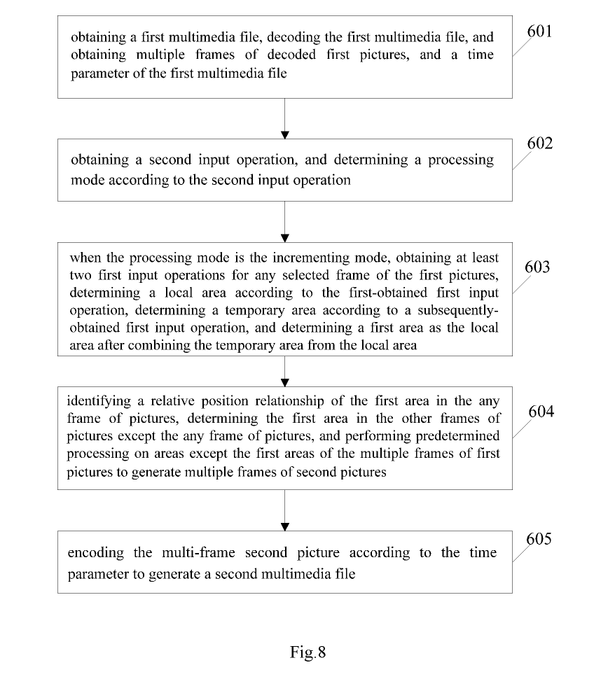

Embodiments of the present disclosure provide an information method. FIG. 8 is a third flowchart of an information processing method according to embodiments of the present disclosure; Referring to FIG. 8, the information processing method includes the followings.

Step 601: obtaining a first multimedia file, decoding the first multimedia file, and obtaining multiple frames of decoded first pictures, and a time parameter of the first multimedia file.

Step 602: obtaining a second input operation, and determining a processing mode according to the second input operation; the processing mode comprises an incrementing mode and a deleting mode.

Step 603: when the processing mode is the incrementing mode, obtaining at least two first input operations for any selected frame of the first pictures, determining a local area according to the first-obtained first input operation, determining a temporary area according to a subsequently-obtained first input operation, and determining a first area as the local area after combining the temporary area from the local area.

Step 604: identifying a relative position relationship of the first area in the any frame of pictures and, according to the relative positional relationship, determining the first area in the other frames of pictures except the any frame of pictures, where the first area of the other frames of pictures satisfy the relative location relationship, and performing predetermined processing on areas except the first areas of the multiple frames of first pictures to generate multiple frames of second pictures.

Step 605: encoding the multiple frames of second pictures according to the time parameter to generate a second multimedia file.

This embodiment is similar to above described Embodiment 5 except that, in Step 603, the processing mode in this embodiment is an incrementing mode. In one embodiment, at least two first input operations are obtained by the mobile terminal. In one embodiment, using two first input operations as an example, the operation trajectory of the first-obtained first input operation is a closed trajectory, such as a closed circle, and the operation trajectory of the first-obtained first input operation with a closed trajectory is determined as the local area. The operation trajectory of the subsequently-obtained first input operation is not limited to whether the operation trajectory is closed or not, and the temporary area is determined according to the subsequently-obtained first input operation. That is, when there are at least two first input operations, the local area is determined by the earliest first input operation that has a closed operation trajectory, all other first input operations are subsequently-obtained first input operations, which is not limited to whether the operation trajectory is closed or not, and the temporary area is determined based on the operation trajectory of the subsequently-obtained first input operation.

In this embodiment, since the processing mode is the incrementing mode, the combination of the local area and the temporary area is determined as the first area. As shown in FIG. 9, A represents a local area, B represents a temporary area, and a shaded area represents a first area obtained. As shown in FIG. 9, four application scenarios are listed. Scenario a in FIG. 9 indicates when the local area and the temporary area overlap, a first area obtained is equivalent to the local area and the temporary area being added together. Scenario b in FIG. 9 indicates when the local area is smaller than the temporary area, and the temporary area completely covers the local area. The first area obtained is equivalent to the temporary area. Scenario c in FIG. 9 indicates that the local area and the temporary area do not overlap, so the first area obtained is the local area and the temporary area added together. Scenario d in FIG. 9 indicates that the local area overlaps with the temporary area, the temporary area is smaller than the local area, and the local area covers the temporary area. The first area obtained is equivalent to the local area.

By adopting the technical solutions in the embodiments of the present invention, on one hand, local processing in a dynamic picture is implemented, that is, a dynamic effect of a local area in a dynamic picture is preserved, and a static display effect is displayed except for the local area. On the other hand, the addition of the processing mode (incrementing mode) facilitates the user in the image processing operation, which improve the user's operating experience and fun.

The technical solution in the embodiments of the present disclosure may be applied to the following scenarios: when a mobile terminal obtains a dynamic picture and the dynamic picture contains a person with two arms swinging and a background with a dynamic effect, the user only wants to keep the dynamic effect of the two arms and do not want the rest of the dynamic effect. According to the technical solutions disclosed in the embodiments of the present disclosure, the first areas for the dynamic effect of the two arms can be determined through the first input operation; all the other areas can be filled so as to finally generate a new dynamic picture that only contains the dynamic effect of the swinging two arms.

It should be noted that in the present disclosure, the terms ‘comprising’, ‘including’ or any other variant which is intended to encompass a non-exclusive inclusion, so as to include a series of elements of process, method, material or apparatus, and not only include those elements, but also include other elements that are not explicitly listed, or the elements that are inherent to these process, method, material or apparatus. In the absence of more restrictions, the elements defined by the statement ‘comprising a . . . ’ do not exclude the presence of the other same elements in the process, method, material or apparatus that includes the elements.

The above described embodiments of the present disclosure are only for the sake of description and do not represent the pros and cons of the embodiments.

In the several embodiments provided in the present disclosure, it should be understood that the disclosed apparatuses and methods may be implemented in other manners. The device embodiments described above are merely exemplary. For example, the unit division is merely logical function division and may be other division in actual implementation. For example, multiple units or components may be combined or can be integrated into another system, or some features can be ignored or not executed. Additionally, the various components illustrated or discussed in connection with each other, or directly coupled, or communicatively coupled, may be indirectly coupled or communicatively coupled through some interface, device or unit, which may be electrically, mechanically or otherwise.

The units described above as separate components may or may not be physically separated. Components displayed as units may or may not be physical units, may be located in one place or may be distributed to multiple network units, some or all of the units may be selected according to actual needs to achieve the objectives of the solutions in this embodiment.

In addition, each of the functional units in the embodiments of the present disclosure may be entirely integrated in one processing unit, or each unit may be used as a single unit, or two or more units may be integrated in one unit. The above integrated unit can be implemented in the form of hardware or the combination of hardware and software functioning unit.

Persons of ordinary skill in the field should understand that, all or a part of the steps of implementing the foregoing method embodiments may be implemented by related hardware of a program instruction. The foregoing program may be stored in a computer-readable storage medium and, when executed, the program executes including the steps of the above method embodiments. The foregoing storage medium includes various types of storage media, such as a removable storage device, a read-only memory (ROM), a random-access memory (RAM), a magnetic disk, and media that can store program code.

Alternatively, when the above-mentioned integrated unit of the present disclosure is implemented in the form of a software functional module and is sold or used as an independent product, the integrated unit may also be stored in a computer-readable storage medium. Based on this understanding, the technical solutions in the embodiments of the present disclosure may be embodied in the form of a software product stored in a storage medium and including several instructions for a computer device (which may be a personal computer, a server, a network device, or the like) executing all or part of the methods described in the embodiments of the present disclosure. The foregoing storage medium includes various media capable of storing program codes, such as a removable storage device, a ROM, a RAM, a magnetic disk, or an optical disk.

The foregoing descriptions are merely specific embodiments of the present disclosure, but the protection scope of the present disclosure is not limited thereto. Anyone skilled in the field may easily conceive changes and substitutions within the technical scope disclosed in the present invention should be covered by the protection scope of the present disclosure. Therefore, the protection scope of the present disclosure should be subject to the protection scope of the claims.

### INDUSTRIAL APPLICABILITY

By adopting the technical solutions in the embodiments of the present invention, local processing in a dynamic picture is implemented, that is, a dynamic effect of a local area in a dynamic picture is preserved, and a static display effect is displayed for other areas except for the local area. In this way, the user's operating experience and fun is improved.

1. A mobile terminal, comprising: a decoding unit, a first processing unit, a second processing unit, and an encoding unit; wherein:
the decoding unit is configured to obtain a first multimedia file, decode the first multimedia file, and obtain multiple frames of decoded first pictures and a time parameter of the first multimedia file;
the first processing unit is configured to obtain a first input operation for any selected frame of the first pictures obtained by the decoding unit;
the second processing unit is configured to determine a first area in the selected frame of the first pictures based on the first input operation, identify an area in each of the other frames of the first pictures except the selected frame of the first pictures corresponding to the first area of the selected frame as a first area of each of the other frames, and perform predetermined processing on areas except the first areas of the multiple frames of first pictures to generate multiple frames of second pictures; and
the encoding unit is configured to encode the multiple frames of second pictures according to the time parameter to generate a second multimedia file.

2. The mobile terminal according to claim 1, wherein:
the second processing unit is further configured to identify a relative position relationship of the first area in the selected frame and, according to the relative positional relationship, determine the first areas in the other frames of pictures except the selected frame of the first pictures; and
the first areas of the other frames of pictures satisfy the relative location relationship.

3. The mobile terminal according to claim 1, wherein:
the first processing unit is further configured to obtain a second input operation, and, before obtaining the first input operation for the any selected frame of the first pictures by the decoding unit, determine a processing mode according to the second input operation; and
the processing mode includes an incrementing mode and a deleting mode.

4. The mobile terminal according to claim 3, wherein the second processing unit is further configured to, when the processing mode is the deleting mode, obtain at least two first input operations for the any selected frame of the first pictures, determine a local area according to a first-obtained first input operation, determine a temporary area according to a subsequently-obtained first input operation, and determine the first area by deleting the temporary area from the local area.

5. The mobile terminal according to claim 3, wherein the second processing unit is further configured to, when the processing mode is the incrementing mode, obtain at least two first input operations for the any selected frame of the first pictures, determine a local area according to a first-obtained first input operation, determine a temporary area according to a subsequently-obtained first input operation, and determine the first area by combining the temporary area and the local area.

6. The mobile terminal according to claim 1, further comprising:
a display unit configured to, before obtaining the first input operation corresponding to the any selected frame of first pictures by the first processing unit, arrange the multiple frames of pictures in the order of the multiple frames of pictures, and output and display the arranged multiple frames of pictures.

7. The mobile terminal according to claim 1, wherein:
the second processing unit is configured to, based on a preset processing format, process areas in the multiple frames of first pictures except those satisfying the size of the first area to preserve dynamic effect of the first areas in the multiple frames of first pictures; and
the preset processing format includes a preset data filling format.

8. The mobile terminal according to claim 4, wherein the second processing unit is further configured to determine the local area according to a first-obtained first input operation that has a closed trajectory, and determine the temporary area according to the subsequently-obtained first input operation.

9. The mobile terminal according to claim 8, wherein the first-obtained first input operation is an earliest obtained first input operation that satisfies the closed trajectory, and the subsequently-obtained first input operation includes any first input operation obtained after the first-obtained first input operation.

10. An information processing method, comprising:
obtaining a first multimedia file, decoding the first multimedia file, and obtaining multiple frames of decoded first pictures and a time parameter of the first multimedia file
obtaining a first input operation for any selected frame of the first pictures, and determining a first area in the selected frame of the first pictures based on the first input operation;
identifying an area in each of the other frames of the first pictures except the selected frame of the first pictures corresponding to the first area of the selected frame as a first area of each of the other frames, and perform predetermined processing on areas except the first areas of the multiple frames of first pictures to generate multiple frames of second pictures; and
encoding the multiple frames of second pictures according to the time parameter to generate a second multimedia file.

11. The information processing method according to claim 10, wherein identifying an area in each of the other frames of the first pictures except the selected frame of the first pictures corresponding to the first area of the selected frame as a first area of each of the other frames further comprises:
identifying a relative positional relationship of the first area in the any selected frame of the first pictures;
according to the relative positional relationship, determining the first areas in the other frames of pictures except the selected frame of the first pictures; and
the first areas of the other frames of pictures satisfy the relative location relationship.

12. The information processing method according to claim 10, before obtaining the first input operation, further comprising:
obtaining a second input operation; and
determining a processing mode according to the second input operation, wherein the processing mode includes an incrementing mode and a deleting mode.

13. The information processing method according to claim 12, wherein the processing mode is the deleting mode, and obtaining a first input operation for any selected frame of the first pictures and determining a first area in the selected frame of the first pictures based on the first input operation further comprises:
obtaining at least two first input operations for the any selected frame of the first pictures, determining a local area according to a first-obtained first input operation, determining a temporary area according to a subsequently-obtained first input operation, and determining the first area by deleting the temporary area from the local area.

14. The information processing method according to claim 12, wherein the processing mode is the incrementing mode, and obtaining a first input operation for any selected frame of the first pictures and determining a first area in the selected frame of the first pictures based on the first input operation further comprises:
obtaining at least two first input operations for the any selected frame of the first pictures, determining a local area according to a first-obtained first input operation, determining a temporary area according to a subsequently-obtained first input operation, and determining the first area by combining the temporary area and the local area.

15. The information processing method according to claim 10, before obtaining a first input operation for any selected frame of the first picture, further comprising:
arranging the multiple frames of pictures in the order of the multiple frames of pictures, outputting and displaying the arranged multiple frames of pictures.

16. The information processing method according to claim 10, wherein perform predetermined processing on areas except the first areas of the multiple frames of first pictures to generate multiple frames of second pictures further comprises:
based on a preset processing format, processing areas in the multiple frames of first pictures except those satisfying the size of the first area to preserve dynamic effect of the first areas in the multiple frames of first pictures; and
the preset processing format includes a preset data filling format

17. The information processing method according to claim 13, wherein determining a local area according to a first-obtained first input operation and determining a temporary area according to a subsequently-obtained first input operation further comprises:
determining the local area according to a first-obtained first input operation that has a closed trajectory, and determining the temporary area according to the subsequently-obtained first input operation.

18. The information processing method according to claim 17, wherein the first-obtained first input operation is an earliest obtained first input operation that satisfies the closed trajectory, and the subsequently-obtained first input operation includes any first input operation obtained after the first-obtained first input operation.

19. The information processing method according to claim 15, wherein arranging the multiple frames of pictures in the order of the multiple frames of pictures, outputting and displaying the arranged multiple frames of pictures further comprises:
after the first multimedia file is decoded, from a first frame of pictures obtained, arranging the multiple frames of pictures in a decoding sequence, and outputting and displaying the arranged multiple frames of pictures.

20. A computer storage medium containing computer-executable instructions for, when executed by one or more processors, performing an information processing method, the method comprising:
obtaining a first multimedia file, decoding the first multimedia file, and obtaining multiple frames of decoded first pictures and a time parameter of the first multimedia file
obtaining a first input operation for any selected frame of the first pictures, and determining a first area in the selected frame of the first pictures based on the first input operation;
identifying an area in each of the other frames of the first pictures except the selected frame of the first pictures corresponding to the first area of the selected frame as a first area of each of the other frames, and perform predetermined processing on areas except the first areas of the multiple frames of first pictures to generate multiple frames of second pictures; and
encoding the multiple frames of second pictures according to the time parameter to generate a second multimedia file.
